(19) United States
(12) Patent Application Publication
(10) Pub. No.: US 2018/0354430 A1
(43) Pub. Date: Dec. 13, 2018

(54) ACOUSTIC CAP WITH IMPROVED DAMPING

(71) Applicant: ILLINOIS TOOL WORKS INC., Glenview, IL (US)

(72) Inventor: David DOMINGUEZ, Wolfsburg (DE)

(21) Appl. No.: 15/981,989

(22) Filed: May 17, 2018

(30) Foreign Application Priority Data
Jun. 7, 2017 (DE) 10 2017 112 474.8

(51) Int. Cl. B60R 13/08; B32B 27/06

(52) U.S. Cl. CPC B60R 13/0815; B32B 2605/003; B32B 2307/102; B32B 27/065

(57) ABSTRACT

An acoustic cap for soundproofing and/or damping of a noise source in a vehicle, wherein the acoustic cap includes: a shell as a first proofing and/or damping material and as an outer wall of the acoustic cap, wherein the shell is made of plastic; and a second proofing and/or damping material as an inner, noise source facing wall of the acoustic cap, where one or multiple hollow spaces is or are defined between the first and the second proofing and/or damping material. A method for manufacturing an acoustic cap is also provided.

### TECHNICAL FIELD

The invention relates to the problem of noise proofing and damping in the vehicle interior with regard to noises caused by appliances or devices on the vehicle, such as for example gearboxes, fan grilles, mechanical dampers and motors. The aim is a reduction of the cabin noises.

### BACKGROUND

In the region of air outlets in the vehicle interior, half-open acoustic caps composed of a solid plastics shell and an inner foam lining are used.

The object on which the invention is based was that of improving the reduction of noises in the vehicle interior by means of acoustic caps.

### SUMMARY

The object is achieved by means of the independent claims. Advantageous refinements are defined in the dependent claims.

In particular, the object is achieved by means of an acoustic cap for soundproofing and/or damping of a noise source in a vehicle, wherein the acoustic cap comprises:

a preferably self-supporting and/or shape-imparting shell as a first proofing and/or damping material and as an outer, preferably the outermost wall of the acoustic cap, wherein the shell is made of plastic;

a second proofing and/or damping material, preferably foam material (e.g. PUR or melamine resin) as an inner, preferably the innermost, wall, facing the noise source (or the corresponding location of the noise source in the future installed state), of the acoustic cap, wherein one or more hollow spaces, preferably in the form of an interposed gap, is or are defined between the first and the second proofing and/or damping material, preferably over at least 50%, particularly preferably 75%, very particularly preferably 95% of the area of the second proofing and/or damping material.

The object is furthermore achieved in particular by means of a method for manufacturing an acoustic cap for soundproofing and/or damping of a noise source in a vehicle, comprising the steps:

manufacturing a preferably self-supporting and/or shape-imparting shell of plastic, preferably by means of injection molding, as a first proofing and/or damping material and as an outer, preferably the outermost, wall of the acoustic cap;

manufacturing a second proofing and/or damping material, preferably foam material (e.g. PUR, melamine resin);

placing the second proofing and/or damping material as an inner, preferably the innermost, wall, facing the noise source (or the corresponding location of the noise source in the future installed state), of the acoustic cap, such that one or more hollow spaces, preferably in the form of an interposed gap, is or are defined between the first and the second proofing and/or damping material, preferably over at least 50%, particularly preferably 75%, very particularly preferably 95% of the area of the second proofing and/or damping material.

It has been found that the presence of the hollow spaces improves the damping characteristics of the acoustic cap. It is preferable for at least one, preferably all, of the following external dimensions of the acoustic cap to be smaller than or equal to the respectively stated maximum value: width=maximum 20 cm, length=maximum 20 cm, height=maximum 20 cm. The noise source is for example a gearbox, a fan grille, a mechanical damper, an electric actuating motor, or moving parts that can strike one another and in so doing make a rattling noise. The shell as merely an outer (and not outermost) wall of the acoustic cap may for example be covered by a further material layer. The second proofing and/or damping material as an inner (and not innermost) wall of the acoustic cap may for example be covered by a further material layer. If a foam material is used, an open-pored or closed-pored foam material may be used. For better damping, it is preferably open-pored, very particularly preferably permeable to air. The cap is preferably provided as a retrofit part. The first proofing and/or damping material preferably has predominately a soundproofing characteristic, whereas the second proofing and/or damping material has a predominantly sound damping characteristic.

In a further exemplary embodiment of the present invention, the shell comprises one or multiple spacers on its inner face and the second proofing and/or damping material lies against the one or multiple spacers. In a further method according to the invention, the second proofing and/or damping material is, during the placement, laid onto the one or multiple spacers. This yields an advantageous and simple form and minimum size of the hollow space or of the hollow spaces. The air gap or acoustic spacing that exists between the two proofing and/or damping materials can be optimally set and ensured by means of the one or multiple spacers. The one or multiple spacers preferably define(s) the size of the one or multiple hollow spaces.

In a further exemplary embodiment of the present invention, the one or multiple spacers are formed integrally with the shell. In a further method according to the invention, the one or multiple spacers are jointly formed during the manufacture of the shell. In this way, a sandwich structure with hollow spaces is created using only two proofing and/or damping materials and in a simple manner.

In a further exemplary embodiment of the present invention, the one or multiple spacers is or are formed as one or multiple ribs and/or form a grid of ribs. In a further method according to the invention, corresponding spacers are formed. This yields a highly advantageous form of the spacers, in particular with regard to manufacturing in an injection-molding process.

In a further exemplary embodiment of the present invention, the shell substantially, preferably completely, encloses a half space by means of its wall or walls. In this way, a noise source can advantageously be substantially, preferably completely, encapsulated and thus soundproofed and damped in a highly effective manner. For this purpose, the acoustic cap preferably has at least one curved wall, or only and at least three non-curved walls which are angled relative to one another.

In a further exemplary embodiment of the present invention, the shell encloses an air channel by means of its side wall or side walls, which air channel preferably has an inlet opening and an outlet opening. In this way, it is for example possible for a ventilation opening as a noise source to be soundproofed and damped in an advantageous manner, without the air flow being unduly impaired in the process. For this purpose, the acoustic cap preferably has at least one curved wall, or only and at least two non-curved walls which are angled relative to one another.

In a further exemplary embodiment of the present invention, the shell has fastening means for fastening the acoustic cap in the vehicle, for example one or more eyelets and/or hooks. In this way, the cap can be easily fastened on the vehicle. The fastening means are preferably formed integrally with the shell, preferably by means of injection molding. In a corresponding method according to the invention, the fastening means are preferably injection-molded integrally with the shell.

In a further exemplary embodiment of the present invention, the second proofing and/or damping material is fastened to the shell by means of clips. In a further method according to the invention, the second proofing and/or damping material is fastened to the shell by means of clips. In this way, the second proofing and/or damping material is advantageously held in the correct position, wherein the installation is straightforward owing to the clips.

In a further exemplary embodiment of the present invention, the second proofing and/or damping material is a foam material, which is foamed, preferably directly, as a preferably continuous layer, onto the one or the multiple spacers. In a further method according to the invention, the manufacture and placement of the second proofing and/or damping material is performed in one step by means of the foaming of the second proofing and/or damping material onto the one or the multiple spacers. In this way, the manufacturing process is made automatable. For this purpose, spacers are preferably spaced apart from one another to such a small extent that one coherent foam layer is formed during the foaming-on process.

### BRIEF DESCRIPTION OF THE DRAWINGS

The invention will now be illustrated in more detail by way of an example on the basis of drawings, in which:

FIG. 1A shows a section through an acoustic cap according to the invention,

FIG. 1B shows a perspective view from below of the shell of the acoustic cap from FIG. 1A,

FIG. 2A shows a perspective view from below of a refinement of the acoustic cap from FIGS. 1A and 1B,

FIG. 2B shows a section through the acoustic cap as per FIG. 2B,

FIG. 3 shows a perspective view of a further variant of an acoustic cap according to the invention.

### DETAILED DESCRIPTION

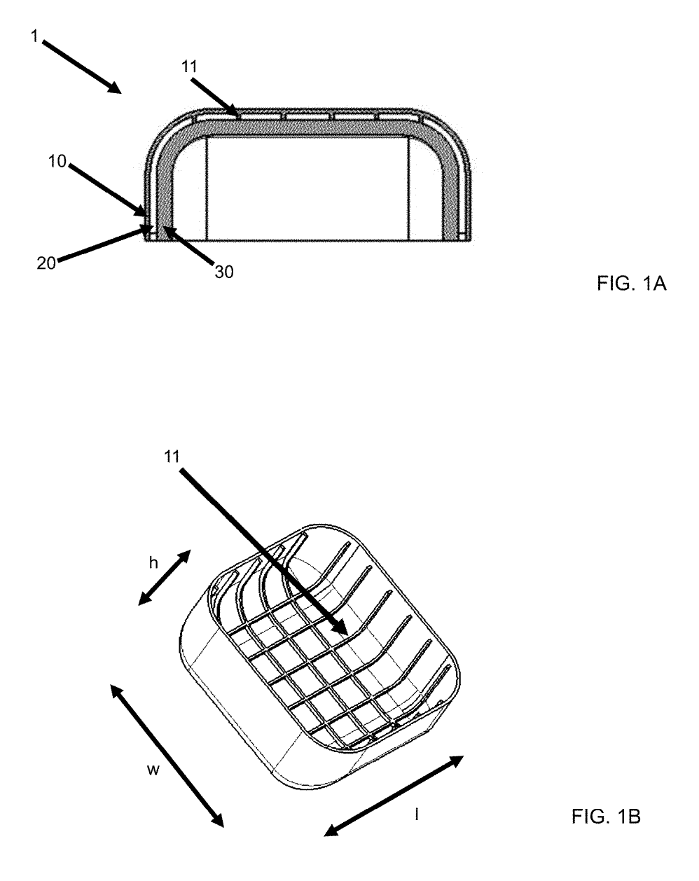

FIG. 1A shows a section through an acoustic cap according to the invention, and FIG. 1B shows a perspective view from below of the shell of the acoustic cap from FIG. 1A. The acoustic cap 1 is designed for soundproofing of a noise source in a vehicle. Said acoustic cap has a self-supporting and shape-imparting shell 10 as a first proofing and/or damping material and as the outermost wall of the acoustic cap 1, wherein the shell 10 is manufactured from injection-molded plastic. The acoustic cap furthermore has a second proofing and/or damping material 30, in this case a foam material, as the inner most wall, facing the noise source, of the acoustic cap 1. Multiple hollow spaces 20 are defined between the first and the second proofing and/or damping material 10, 30.

Furthermore, the shell 10 comprises multiple spacers 11 on its inner face or inner main surface and the second proofing and/or damping material 30 lies against the multiple spacers 11. The multiple spacers 11 are formed integrally with the shell 10. Said spacers are formed as multiple ribs and form a grid of ribs. Furthermore, width w, length 1 and height h are shown in FIG. 1B. The shell 10 completely encloses a half space by means of its wall or walls.

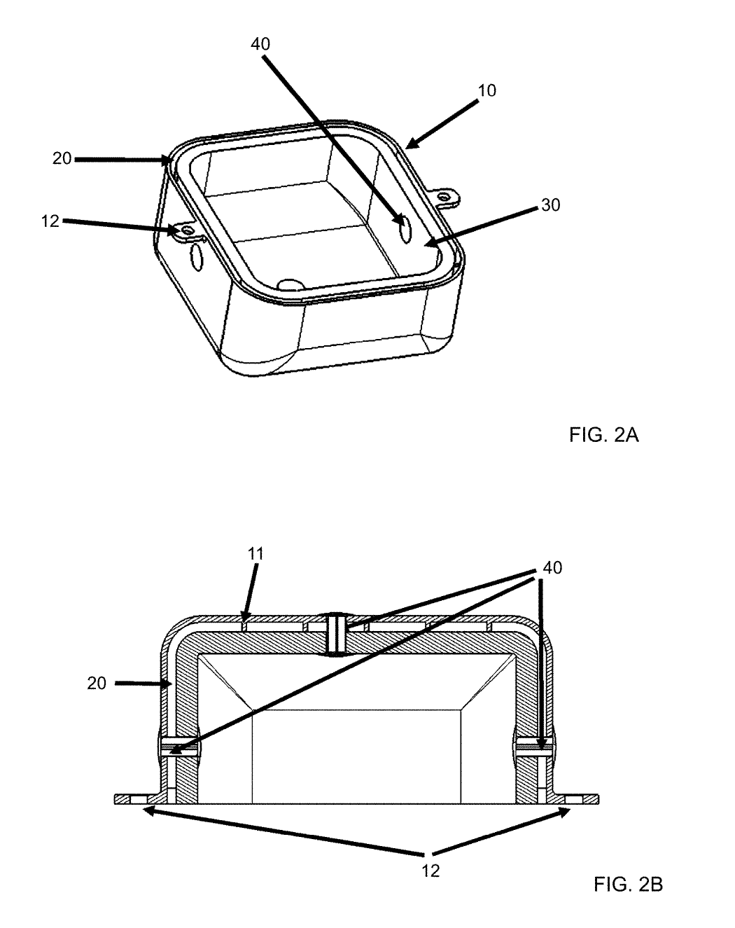

FIG. 2A shows a perspective view from below of a refinement of the acoustic cap from FIGS. 1A and 1B. FIG. 2B shows a section through the acoustic cap as per FIG. 2A. Additionally in relation to the acoustic cap from FIGS. 1A and 1B, the shell 10 has fastening means 12 for fastening the acoustic cap 1 in the vehicle, in this case two eyelets. Furthermore, the second proofing and/or damping material 30 is fastened to the shell 10 by means of clips.

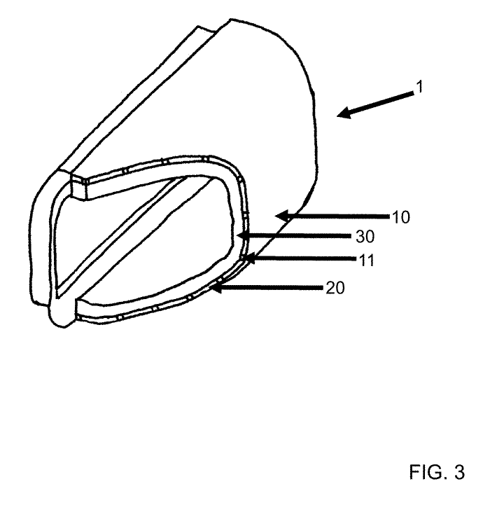

FIG. 3 shows a perspective view of a further variant of an acoustic cap according to the invention. By contrast to the acoustic cap 1 as per FIGS. 1A, 1B and 2A, 2B, the shell 10 encloses an air channel by means of its walls, wherein the air channel has an inlet opening and an outlet opening. Otherwise, this acoustic cap also has the features of the acoustic cap from FIGS. 1A, 1B and optionally also those of the acoustic cap from FIGS. 2A, 2B.

### LIST OF REFERENCE DESIGNATIONS

1 Acoustic cap
10 Shell, first proofing and/or damping material
11 Spacer
12 Fastening means
20 Hollow space
30 Second proofing and/or damping material
40 Clips
w Width
l Length
h Height

What is claimed is:

1. An acoustic cap for sound proofing and/or damping of a noise source in a vehicle, wherein the acoustic cap comprises:
a shell as a first proofing and/or damping material and as an outer wall of the acoustic cap, wherein the shell is made of plastic;
a second proofing and/or damping material as an inner, noise source facing wall of the acoustic cap, wherein one or multiple hollow spaces is or are defined between the first proofing and/or damping material and the second proofing and/or damping material.

2. The acoustic cap according to claim 1, wherein the shell comprises one or multiple spacers on its inner face and the second proofing and/or damping material lies against the one or multiple spacers.

3. The acoustic cap according to claim 2, wherein the one or multiple spacers are integrally formed with the shell.

4. The acoustic cap according to claim 3, wherein the one or multiple spacers are built as one or multiple ribs and/or a grid of ribs.

5. The acoustic cap according to claim 1, wherein the shell completely encloses a half space by means of one or more walls of the shell.

6. The acoustic cap according to claim 4, wherein the shell encloses an air channel by means of the one or more walls.

7. The acoustic cap according to claim 1, wherein the shell comprises fastening means for fastening the acoustic cap in the vehicle.

8. The acoustic cap according to claim 1, wherein the second proofing and/or damping material is fastened to the shell by means of clips.

9. The acoustic cap according to claim 2, wherein the second proofing and/or damping material is a foam material, which is foamed onto the one or the multiple spacers as a layer.

10. A method for manufacturing an acoustic cap for use in sound proofing and/or damping of a noise source in a vehicle, comprising the steps:
manufacturing a shell of plastic as a first proofing and/or damping material and as an outer wall of the acoustic cap;
manufacturing a second proofing and/or damping material;
placing the second proofing and/or damping material as an inner, noise source facing wall of the acoustic cap, such that between the first proofing and/or damping material and the second proofing and/or damping material one or multiple hollow spaces is or are defined.

11. An acoustic cap for sound proofing and/or damping of a noise source in a vehicle, wherein the acoustic cap comprises:
a shell as a first proofing and/or damping material and as an outer wall of the acoustic cap, wherein the shell is made of plastic, wherein the shell includes an inner main surface;
a second proofing and/or damping material positioned within the shell as an inner, noise source facing wall of the acoustic cap, wherein one or multiple hollow spaces is or are defined between the internal primary surface of the shell and the second proofing and/or damping material.

12. The acoustic cap of claim 11, wherein the shell comprises one or multiple spacers on the inner main surface and the second proofing and/or damping material lies against the one or multiple spacers.

13. The acoustic cap according to claim 12, wherein the one or multiple spacers are integrally formed with the shell and protrude from the inner main surface.

14. The acoustic cap according to claim 13, wherein the one or multiple spacers are configured as one or multiple ribs or a grid of ribs that are molded unitary with shell.
